(19) United States
(12) Patent Application Publication
(10) Pub. No.: US 2017/0031456 A1
(43) Pub. Date: Feb. 2, 2017

(54) OPERATION PANEL, IMAGE FORMING DEVICE PROVIDED WITH SAME, AND IMAGE READING DEVICE

(71) Applicant: KYOCERA Document Solutions Inc., Osaka (JP)

(72) Inventors: Tetsuya ICHIGUCHI, Osaka (JP); Hiroyuki TANAKA, Osaka (JP); Motoyuki FUKUDA, Osaka (JP)

(73) Assignee: KYOCERA Document Solutions Inc., Osaka (JP)

(21) Appl. No.: 15/304,055

(22) PCT Filed: Oct. 22, 2015
(86) PCT No.: PCT/JP2015/079791

§ 371 Date: Oct. 13, 2016

(30) Foreign Application Priority Data
Feb. 26, 2015 (JP) 2015-036255

(51) Int. Cl. G06F 3/02; H01H 3/12; H04N 1/00

(52) U.S. Cl. CPC G06F 3/0202; H04N 1/00384; H04N 1/00496; H01H 3/12; H04N 2201/0094; H01H 2231/016

(57) ABSTRACT

Provided are an operation panel capable of reliably pressing down a target operation key while saving arrangement space of operation keys, an image forming device provided with the same, and an image reading device. An operation panel (3) is provided with a main body unit (10) having a panel surface (10a) tilted with respect to a horizontal direction and operation keys (12 to 16) protruded from the panel surface. The operation keys have operation surfaces (12a to 16a) pressed down by a user and protrusion portions (12b to 16b) formed so as to be protruded from the operation surfaces along lower end portions of the operation surfaces.

### TECHNICAL FIELD

The present invention relates to an operation panel that includes a body having a panel surface inclined with respect to the horizontal direction and that includes a plurality of operation keys, and also relates to an image forming apparatus (image forming device) and an image reading device provided with such an operation panel.

### BACKGROUND ART

Conventionally, image forming apparatuses such as copiers, printers, and facsimile machines and image reading devices such as scanners incorporate an operation panel to permit a user various settings. In recent years, as image forming apparatuses and image reading devices are made compact, their operation panels are made compact, and this makes it necessary to reduce the intervals between operation keys. As a result, on an operation panel with a panel surface inclined with respect to the horizontal direction, a user's finger may slip over the operation keys and press an operation key different from the intended one.

To overcome the inconvenience, for example, Patent Document 1 discloses a panel switch (operation panel) in which a convexity is provided separately in a lower or side part of a push button switch (operation key).

### LIST OF CITATIONS

### Patent Literature

Patent Document 1: JP-U-H02-143732

### SUMMARY OF THE INVENTION

### Technical Problem

However, according to the operation panel of Patent Document 1 mentioned above, with the convexity is arranged between adjacent operation keys, it is difficult to reduce the intervals between the operation keys, and thus to achieve space saving in the space necessary for the arrangement of the operation keys.

Devised against the background discussed above, an object of the present invention is to provide an operation panel that permits an intended operation key to be depressed reliably while achieving space saving in the space necessary for the arrangement of the operation keys, and to provide an image forming apparatus and an image reading device provided with such an operation panel.

### Means for Solving the Problem

According to one aspect of the present invention, an operation panel is incorporated in an image forming apparatus or in an image reading device. The operation panel includes a body having a panel surface which is inclined with respect to the horizontal direction and an operation key protruding from the panel surface. The operation key has an operation surface which is depressed by a user, and has a protruding portion which is formed along a lower end part of the operation surface so as to protrude from the operation surface.

### Advantageous Effects of the Invention

According to the operation panel of the present invention, the operation key has a protruding portion formed along a lower end part of an operation surface so as to protrude from the operation surface. Thus, even when a user's finger slips over the operation surface, the finger is held by the protruding portion, and thus an intended operation key can be reliably depressed.

Unlike in a case where a convexity is arranged between adjacent operation keys (as in Patent Document 1 identified above), it is possible to achieve space saving in the space necessary for the arrangement of the operation keys.

Further features and advantages of the present invention will become apparent from the description of embodiments given below.

### BRIEF DESCRIPTION OF DRAWINGS

FIG. 1 is a perspective view showing a structure of an image forming apparatus provided with an operation panel according to a first embodiment of the present invention;

FIG. 2 is a diagram showing a structure of the operation panel according to the first embodiment of the present invention;

FIG. 3 is a side view showing a structure of and around operation keys of the operation panel according to the first embodiment of the present invention;

FIG. 4 is a side view showing a structure of and around operation keys of the operation panel according to the first embodiment of the present invention;

FIG. 5 is a diagram showing a structure of an operation panel according to a second embodiment of the present invention;

FIG. 6 is a side view showing a structure of an operation panel according to a third embodiment of the present invention;

FIG. 7 is a diagram showing a structure of an operation panel according to a fourth embodiment of the present invention;

FIG. 8 is a side view showing a structure of an operation panel according to a fifth embodiment of the present invention;

FIG. 9 is a side view showing a structure of an operation panel according to a sixth embodiment of the present invention;

FIG. 10 is a side view showing a structure of an operation panel according to a seventh embodiment of the present invention;

FIG. 11 is a side view showing a structure of an operation panel according to an eighth embodiment of the present invention;

FIG. 12 is a diagram showing a structure of operation keys of an operation panel according to a ninth embodiment of the present invention;

FIG. 13 is side view showing a structure of an operation panel according to a tenth embodiment of the present invention;

FIG. 14 is a diagram showing a pen-shaped stick for depressing operation keys of an operation panel of the present invention; and

FIG. 15 is a diagram showing a structure of operation keys of an operation panel according to a modified example of the present invention.

### DESCRIPTION OF EMBODIMENTS

Hereinafter, embodiments of the present invention will be described with reference to the accompanying drawings.

### First Embodiment

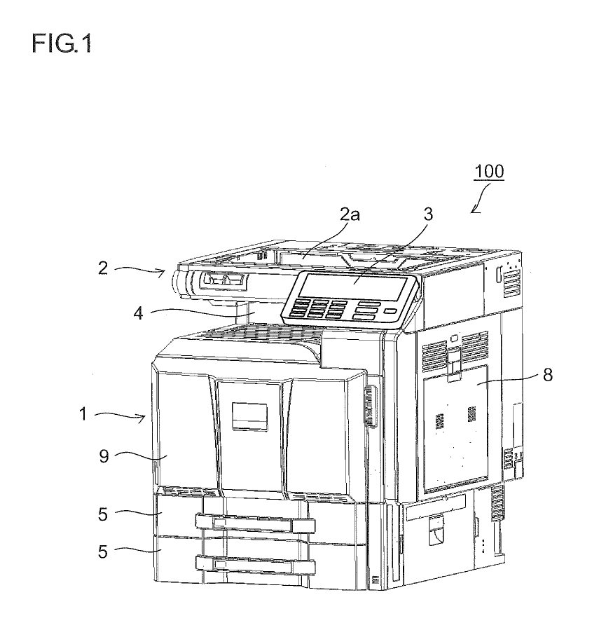

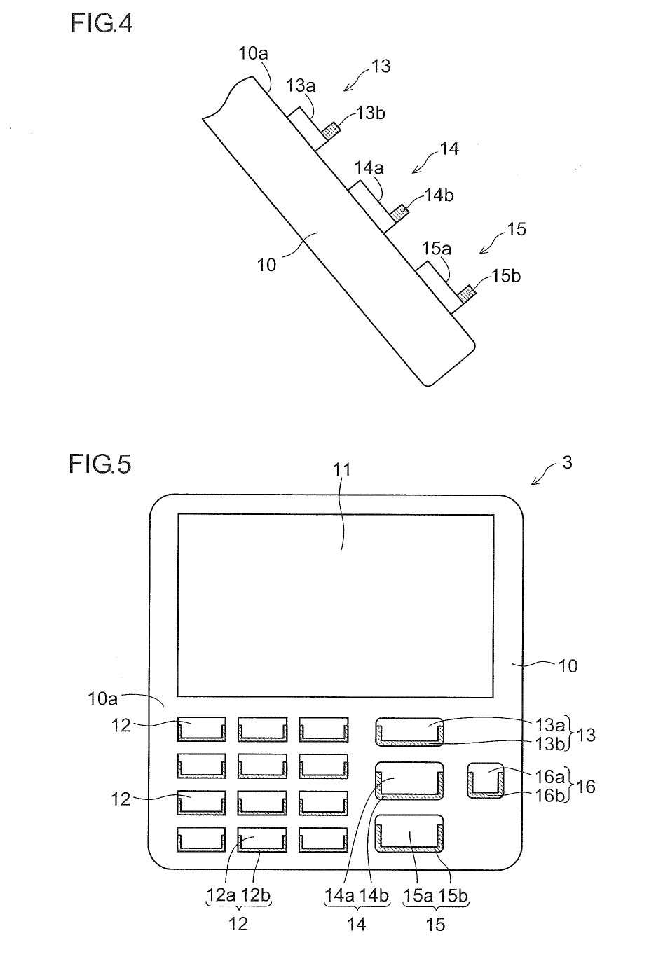

With reference to FIGS. 1 to 4, a description will be given of an image forming apparatus (image forming device) 100 that is provided with an operation panel 3 according to a first embodiment of the present invention. As shown in FIG. 1, the image forming apparatus 100 (here a digital multifunction peripheral is taken as an example) includes an apparatus main body 1 and an image reading portion 2, which is arranged in an upper part of the apparatus main body 1.

Inside the image reading portion 2, a reading portion is arranged that reads image information of a document on a contact glass 2a. The reading portion is composed of a scanning optical system that incorporates a scanner lamp for illuminating a document during copying and a mirror for changing the optical path of light reflected from the document, a converging lens for converging the light reflected from the document to form an image, a CCD (charge-coupled device) sensor for converting image light of the formed image into an electric signal, etc. (none of these is illustrated). The reading portion reads and converts a document image into image data.

In a front part of the image reading portion 2, the operation panel 3 is arranged that has a display portion and operation keys. In an upper part of the image reading portion 2, a platen (unillustrated) is openably/closably arranged that presses a document placed on the contact glass 2a. On the platen, an automatic document transport device (unillustrated) may be provided that automatically feeds one document sheet after another sequentially out of a document bundle onto the contact glass 2a.

Between the image reading portion 2 and the apparatus main body 1, an internal sheet discharge space 4 is arranged that is widely open to the left side face and the front face.

In a front part of the apparatus main body 1, a plurality (here two) of sheet feed cassettes 5 for storing sheets (recording medium) are arranged so as to be removable from the apparatus main body 1.

Inside the apparatus main body 1, there are arranged an image forming portion, a fixing portion, a sheet transport portion, etc., which are unillustrated. Based on image data read by the image reading portion 2, the image forming portion transfers a toner image to a sheet, which is fed to it, to form an image. The image forming portion includes a photosensitive drum for carrying an electrostatic latent image, a charging unit for electrostatically charging the surface of the photosensitive drum, an exposure unit for forming an electrostatic latent image corresponding to a document image on the surface of the photosensitive drum by a laser beam or the like, a developing unit for forming a toner image by attaching developer to the formed electrostatic latent image, a transfer roller for transferring the toner image to a sheet, and a cleaning blade for removing toner left unused on the surface of the photosensitive drum, etc. The fixing portion heats and presses the sheet having the toner image transferred to it, thereby fixing the toner image to the sheet. The sheet transport portion (unillustrated) extends upward along the right side surface of the apparatus main body 1, and transports a sheet from the sheet feed cassettes 5 to the image forming portion.

In a lower right part of the inside of the apparatus main body 1, there is arranged a sheet feed portion (unillustrated) that feeds a sheet from the sheet feed cassettes 5 and transports the sheet to the sheet transport portion (unillustrated) arranged above. On the right side surface and the front surface of the apparatus main body 1, there are openably/closably arranged, respectively, a right cover member 8 that covers a right side of the sheet transport portion and a front cover member 9.

Next, the structure of the operation panel 3 will be described.

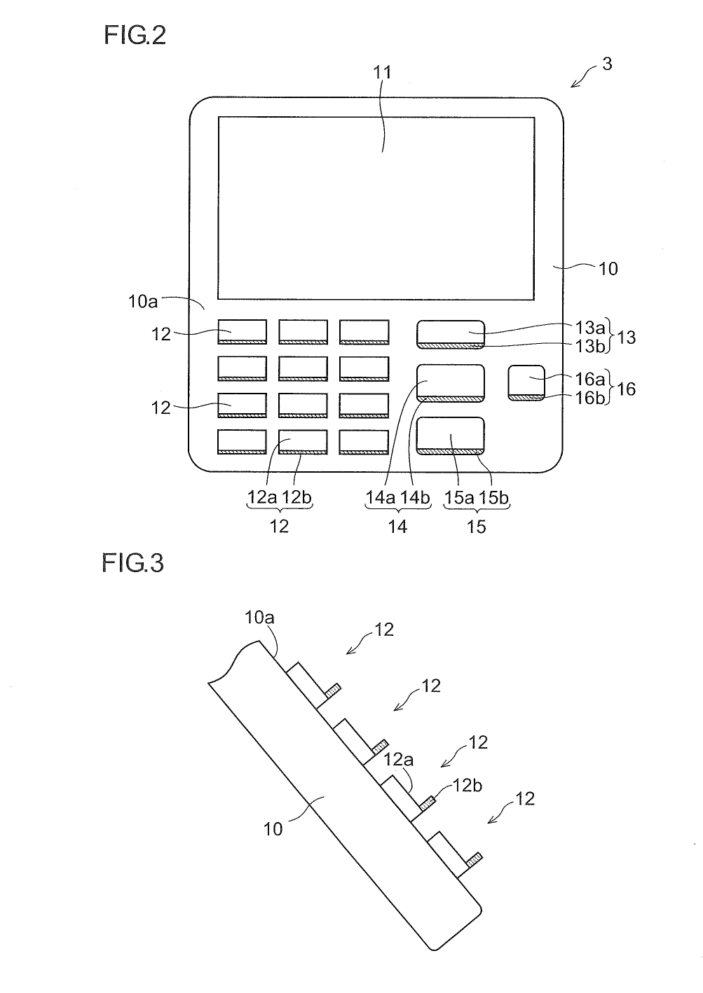

As shown in FIGS. 2 to 4, the operation panel 3 includes a body 10 having a panel surface 10a, a display panel 11 arranged in an upper opening in the panel surface 10a, and a plurality of operation keys 12, 13, 14, 15, and 16 protruding from the panel surface 10a.

The display panel 11 is a liquid crystal display panel in a rectangular shape, and may have, on the display face side (upper side), a touch panel which a user touches to perform input operation. The display panel 11 displays information related to image formation, an image of buttons for touch panel operation, and the like.

The panel surface 10a of the body 10 is inclined with respect to the horizontal direction, here at 45 degrees or more with respect to the horizontal direction. The operation keys 12 to 16 are arranged in a predetermined region (here a lower region) on the panel surface 10a. For example, a plurality of operation keys 12 are arranged which serve as a numeric keypad for receiving numerical input and the like by a user. For another example, the operation key 13 is a Clear/Stop key, the operation key 14 is a Start key for monochrome images, the operation key 15 is a Start key for color images, and the operation key 16 is a Power key.

The plurality of operation keys 12 are arranged in a matrix-like array at predetermined intervals from one another. The operation keys 13 to 15 are arranged in a row at predetermined intervals from one another. The operation key 16 is arranged at a predetermined distance from the operation keys 13 to 15 in the lateral direction.

As shown in FIGS. 2 to 4, the operation keys 12, 13, 14, 15, and 16 respectively have operation surfaces 12a, 13a, 14a, 15a, and 16a, which are depressed by a user, and have protruding portions 12b, 13b, 14b, 15b, and 16b, which are formed along lower end parts of the operation surfaces 12a, 13a, 14a, 15a, and 16a. In the drawings, to facilitate understanding, the protruding portions 12b to 16b are indicated by hatching.

The operation keys 12 to 16 are made of resin, and the protruding portions 12b to 16b are formed integrally with the operation keys 12 to 16 respectively. The protruding portions 12b to 16b protrude in the direction perpendicular to the operation surfaces 12a to 16a.

In this embodiment, as described above, the operation keys 12 to 16 have the protruding portions 12b to 16b formed along the lower end parts of the operation surfaces 12a to 16a so as to protrude from the operation surfaces 12a to 16a. Thus, even when a user's finger slips over the operation surfaces 12a to 16a, the finger is held by the protruding portions 12b to 16b, and thus the intended one of the operation keys 12 to 16 can be reliably depressed. Thus, even when the intervals between the operation keys 12 to 15 are small in the up/down direction, it is possible to prevent the operation keys 12 to 15 from being erroneously pressed.

Unlike in a case where a convexity is arranged between adjacent operation keys (as in Patent Document 1 identified above), it is possible to reduce the intervals between the operation keys 12 to 16, and thereby to achieve space saving in the space necessary for the arrangement of the operation keys 12 to 16.

The protruding portions 12b to 16b are formed integrally with the operation keys 12 to 16, and thus, the operation keys 12 to 16 can be depressed by depressing protruding portions 12b to 16b. This helps improve the operability of the operation keys 12 to 16.

When the panel surface 10a is inclined at 45 degrees or more with respect to the horizontal direction, a user's finger is more likely to slip and thus to press the operation keys 12 to 16 erroneously. Thus, it is notably effective when the present invention is applied to an operation panel 3 inclined at 45 degrees or more with respect to the horizontal direction as described above.

### Second Embodiment

In a second embodiment, as shown in FIG. 5, protruding portions 12b to 16b are formed in a U-shape so as to be erect along left and right side end parts from opposite ends of lower end parts of the operation surfaces 12a to 16a. The protruding portions 12b to 16b may be provided in a form divided into a lower end part and a side end part of the operation surfaces 12a to 16a.

Otherwise, the structure in the second embodiment is similar to that in the previously-described first embodiment.

In this embodiment, as described above, the protruding portions 12b to 16b are formed also in side end parts of the operation surfaces 12a to 16a. Thus, even when a user's finger slips sideways, the finger is held by the protruding portions 12b to 16b, and thus the intended one of the operation keys 12 to 16 can be depressed more reliably.

Otherwise, the effects of the second embodiment are similar to those of the previously-described first embodiment.

### Third Embodiment

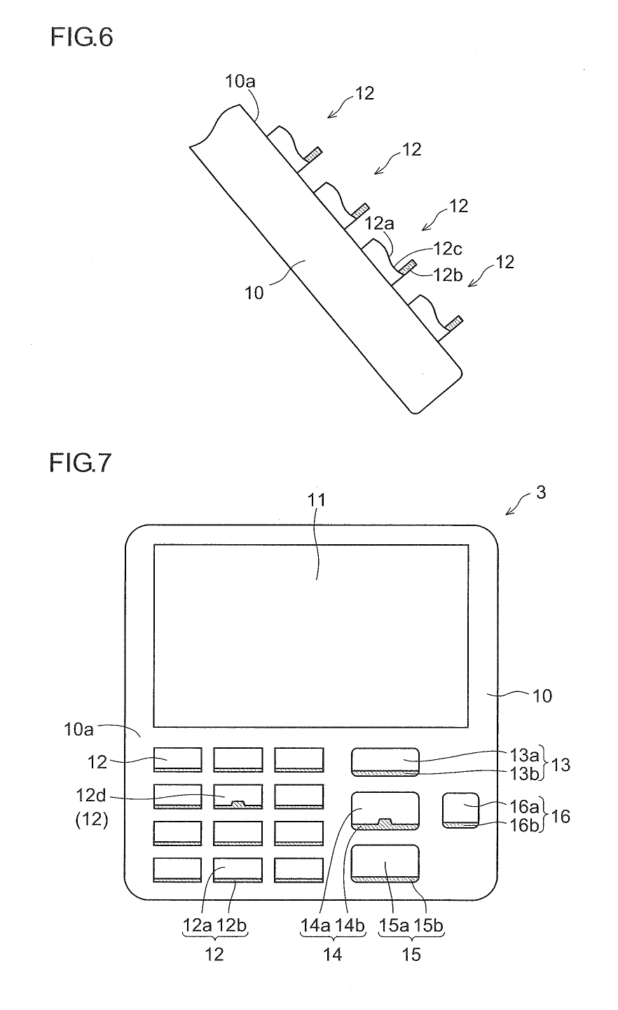

In a third embodiment, as shown in FIG. 6, in a lower end part-side portion of an operation surface 12a, a concavity 12c is formed. As shown in FIG. 6, the concavity 12c may be formed as a deep concavity as compared with its upper end part-side portion or as compared with its side end part-side portion. In other words, the concavity 12c may be formed in a concave shape along the up/down direction (longitudinal direction) or along the left/right direction (lateral direction). The concavity 12c may also be formed to be concave along the up/down direction and along the left/right direction.

Also for the operation keys 13 to 16, like the operation keys 12, a concavity may be formed in lower end part-side portions of the operation surfaces 13a to 16a.

Otherwise, the structure in the third embodiment is similar to that in the previously-described first embodiment.

In this embodiment, as described above, in a lower end part-side portion of the operation surface 12a, the concavity 12c is formed. This permits a user's fingertip to fit the operation surface 12a easily with the user's finger held by the operation surface 12a and the protruding portion 12b, and thus helps improve the operability of the operation keys 12.

Otherwise, the effects of the third embodiment are similar to those of the previously-described first embodiment.

### Fourth Embodiment

In a fourth embodiment, as shown in FIG. 7, a predetermined (here the central) operation key 12d (for example, an operation key 12 corresponding to the number “five”) of the plurality of operation keys 12 has a protruding portion 12b whose shape differs from the other operation keys 12. For example, the protruding portion 12b of the operation key 12d is so formed that a position (in a central part in the left/right direction) where a user's finger easily touches protrudes upward along the operation surface 12a.

A predetermined (here the central) operation key 14 of the plurality of operation keys 13 to 15 has a protruding portion 14b whose shape differs from the operation keys 13 and 15. For example, the protruding portion 14b of the operation key 14 is so formed, like the protruding portion 12b of the operation key 12d, that a position (in a central part in the left/right direction) where a user's finger easily touches protrudes upward along the operation surface 14a.

Otherwise, the structure in the fourth embodiment is similar to that in the previously-described first embodiment.

In this embodiment, as described above, the central operation key 12d of the plurality of operation keys 12 has the protruding portion 12d whose shape differs from the other operation keys 12. The central operation key 14 of the plurality of operation keys 13 to 15 has the protruding portion 14b whose shape differs from the operation keys 13 and 15. Thus, it is possible to find where the operation keys 12d and 14 are by groping for them (only at a fingertip).

Otherwise, the effects of the fourth embodiment are similar to those of the previously-described first embodiment.

### Fifth Embodiment

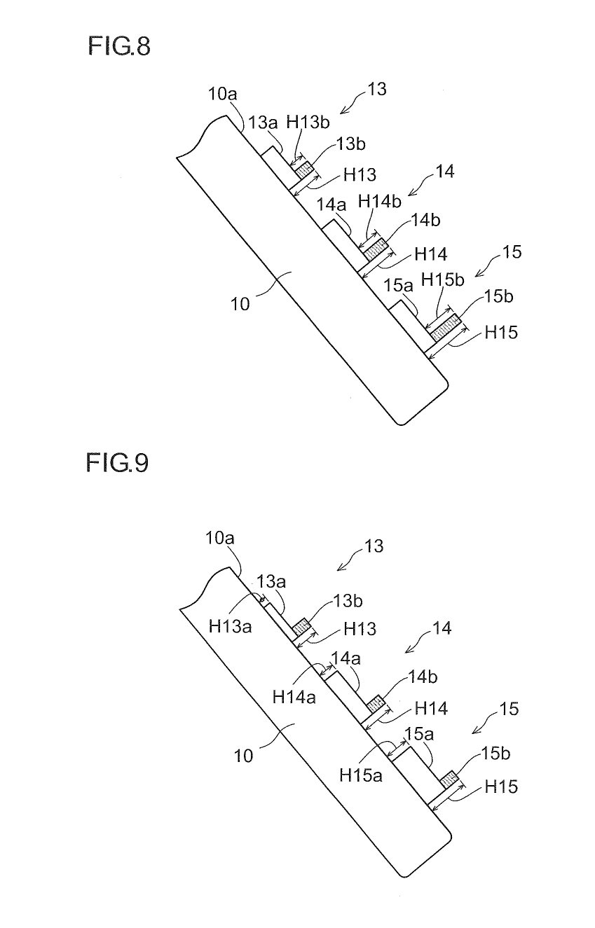

In a fifth embodiment, as shown in FIG. 8, operation keys 13 to 15 are formed such that a lower operation key has a larger protrusion amount of the protruding portions 13b to 15b with respect to the operation surfaces 13a to 15a than that of an upper operation key. That is, the protrusion amount H14b of the protruding portion 14b with respect to the operation surface 14a of the operation key 14 is larger than the protrusion amount H13b of the protruding portion 13b with respect to the operation surface 13a of the operation key 13. Likewise, the protrusion amount H15b of the protruding portion 15b with respect to the operation surface 15a of the operation key 15 is larger than the protrusion amount H14b of the protruding portion 14b with respect to the operation surface 14a of the operation key 14.

Accordingly, the operation keys 13 to 15 are formed such that a lower operation key has a larger protrusion amount of the protruding portions 13b to 15b with respect to the panel surface 10a than that of an upper operation key. That is, the protrusion amount H14 of the protruding portion 14b with respect to the panel surface 10a is larger than the protrusion amount H13 of the protruding portion 13b with respect to the panel surface 10a. Likewise, the protrusion amount H15 of the protruding portion 15b with respect to the panel surface 10a is larger than the protrusion amount H14 of the protruding portion 14b with respect to the panel surface 10a.

Also for the operation keys 12, like the operation keys 13 to 15, a configuration may be adopted in which a lower operation key has a larger protrusion amount of the protruding portion 12b with respect to the operation surface 12a than that of an upper operation key.

Otherwise, the structure in the fifth embodiment is similar to that in the previously-described first embodiment.

In this embodiment, as described above, the operation keys 13 to 15 are formed such that a lower operation key has a larger protrusion amount H13 to H15 of the protruding portions 13b to 15b with respect to the panel surface 10a than that of an upper operation key. This makes it easy to press a lower operation key. On the operation panel 3 of which the panel surface 10a is inclined with respect to the horizontal direction, it is more difficult to press a lower operation key than an upper operation key, and particularly, when the protruding portions 13b to 15b are formed in lower end parts of the operation surfaces 13a to 15a, it is still more difficult to press a lower operation key than an upper operation key. Thus, as described above, making it easy to press a lower operation key by adopting a configuration in which a lower operation key has a larger protrusion amount H13 to H15 than that of an upper operation key is particularly effective.

As described above, the operation keys 13 to 15 are formed such that a lower operation key has a larger protrusion amount H13b to H15b of the protruding portions 13b to 15b with respect to the operation surfaces 13a to 15a than that of an upper operation key. Accordingly, the operation keys 13 to 15 can be easily formed such that a lower operation key has a larger protrusion amount H13 to H15 than that of an upper operation key.

Otherwise, the effects of the fifth embodiment are similar to those of the previously-described first embodiment.

### Sixth Embodiment

In a sixth embodiment, as shown in FIG. 9, operation keys 13 to 15 are formed such that a lower operation key has a larger protrusion amount of the operation surfaces 13a to 15a with respect to the panel surface 10a than that of an upper operation key. That is, the protrusion amount H14a of the operation surface 14a with respect to the panel surface 10a is larger than the protrusion amount H13a of the operation surface 13a with respect to the panel surface 10a. Likewise, the protrusion amount H15a of the operation surface 15a with respect to the panel surface 10a is larger than the protrusion amount H14a of the operation surface 14a with respect to the panel surface 10a.

Accordingly, as in the previously-described fifth embodiment, the operation keys 13 to 15 are formed such that a lower operation key has a larger protrusion amount of the protruding portions 13b to 15b with respect to the panel surface 10a than that of an upper operation key. That is, the protrusion amount H14 of the protruding portion 14b with respect to the panel surface 10a is larger than the protrusion amount H13 of the protruding portion 13b with respect to the panel surface 10a. Likewise, the protrusion amount H15 of the protruding portion 15b with respect to the panel surface 10a is larger than the protrusion amount H14 of the protruding portion 14b with respect to the panel surface 10a.

Also for the operation keys 12, like the operation keys 13 to 15, a configuration may be adopted in which a lower operation key has a larger protrusion amount of the operation surface 12a with respect to the panel surface 10a than that of an upper operation key.

Otherwise, the structure in the sixth embodiment is similar to that in the previously-described first embodiment.

In this embodiment, as described above, the operation keys 13 to 15 are formed such that a lower operation key has a larger protrusion amount H13a to H15a of the operation surfaces 13a to 15a with respect to the panel surface 10a than that of an upper operation key. Accordingly, the operation keys 13 to 15 can be easily formed such that a lower operation key has a larger protrusion amount H13 to H15 than that of an upper operation key.

Otherwise, the effects of the sixth embodiment are similar to those of the previously-described first and fifth embodiments.

### Seventh Embodiment

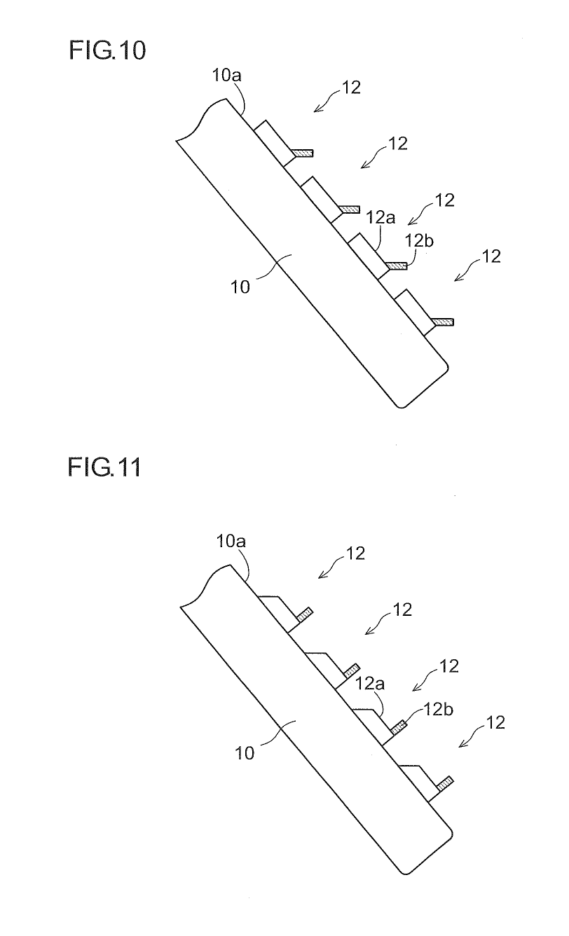

In a seventh embodiment, as shown in FIG. 10, a protruding portion 12b protrudes from the operation surface 12a in the horizontal direction. Also for the operation keys 13 to 16, like the operation keys 12, the protruding portions 13b to 16b may protrude from the operation surfaces 13a to 16a in the horizontal direction.

Otherwise, the structure in the seventh embodiment is similar to that in the previously-described first embodiment.

In this embodiment, as described above, the protruding portion 12b protrudes from the operation surface 12a in the horizontal direction. This helps improve the operability of the operation keys 12.

Otherwise, the effects of the seventh embodiment are similar to those of the previously-described first embodiment.

### Eighth Embodiment

In an eighth embodiment, as shown in FIG. 11, an upper end part of an operation surface 12a is chamfered to direct a user's finger to a lower end part of the operation surface 12a. Also for the operation keys 13 to 16, like the operation keys 12, upper end parts of the operation surfaces 13a to 16a may be chamfered.

Otherwise, the structure in the eighth embodiment is similar to that in the previously-described first embodiment.

In this embodiment, as described above, an upper end part of the operation surface 12a is chamfered. This permits a user's finger to be directed from an upper end part of the operation surface 12a to a lower end part thereof.

Otherwise, the effects of the eighth embodiment are similar to those of the previously-described first embodiment.

### Ninth Embodiment

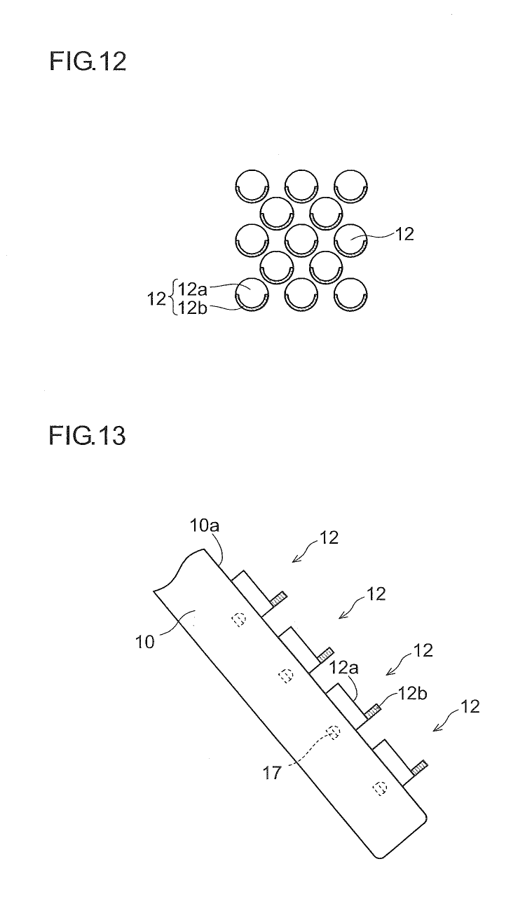

In a ninth embodiment, as shown in FIG. 12, a plurality of operation keys 12 are arranged in a staggered array. When arranged in a staggered array, the operation keys 12 may be formed in a circular shape or an oval shape.

Otherwise, the structure in the ninth embodiment is similar to that in the previously-described first embodiment.

In this embodiment, as described above, by arranging operation keys 12 in a circular shape or an oval shape in a staggered array, it is possible to achieve further space saving of the operation keys 12, while a user is prone to press the operation keys 12 erroneously. Thus, it is notably effective when the present invention is applied to an operation panel 3 on which operation keys 12 are arranged in a staggered array.

Otherwise, the effects of the ninth embodiment are similar to those of the previously-described first embodiment.

### Tenth Embodiment

In a tenth embodiment, as shown in FIG. 13, inside the body 10, there are arranged a plurality of light emitting elements 17 comprising LEDs (light-emitting diodes) or the like. The light emitting elements 17 are arranged so as to emit light toward operation keys 12.

At least protruding portions 12b of the operation keys 12 are formed as a transparent light guiding portion through which light from the light emitting elements 17 is transmitted. The operation keys 12 as a whole including the protruding portions 12b may be formed of transparent resin. Or, only the protruding portions 12b may be formed of transparent resin while the other portions of the operation keys 12 are formed of opaque resin. In this case, a cavity may be formed inside the operation keys 12 so that light from the light emitting elements 17 can reach the protruding portions 12b.

Also for the operation keys 13 to 16, like the operation keys 12, the protruding portions 13b to 16b may be formed as a transparent light guiding portion through which light from the light emitting elements 17 is transmitted.

Otherwise, the structure in the tenth embodiment is similar to that in the previously-described first embodiment.

In this embodiment, as described above, in the body 10, the light emitting elements 17 are arranged, and the protruding portions 12b are formed as a transparent light guiding portion through which light from the light emitting elements 17 is transmitted. Thus, owing to the protruding portions 12b being lit, a user can more easily (seeks to) press the protruding portions 12b. The user's finger is thus more likely to be held by the protruding portions 12b, and thereby the intended one of the operation keys 12 can be depressed more reliably.

Otherwise, the effects of the tenth embodiment are similar to those of the previously-described first embodiment.

It should be understood that the embodiments disclosed herein are in every aspect illustrative and not restrictive. The scope of the present invention is defined not by the description of embodiments given above but by the appended claims, and encompasses many modifications and variations made in the sense and scope equivalent to those of the claims.

For example, although the above-described embodiments deal with, as an example, an image forming apparatus exploiting electrophotography, this is in no way meant to limit the present invention. The present invention is applicable equally to image forming apparatuses adopting other image forming methods such as an inkjet method, a thermal transfer method, etc. The present invention is applicable also to image reading devices such as scanners, etc.

Although the above-described embodiments deal with a case where the panel surface 10a is inclined at 45 degrees or more with respect to the horizontal direction, this is in no way meant to limit the present invention. The panel surface 10a may be inclined less than 45 degrees with respect to the horizontal direction.

Although the above-described embodiments deal with an example where all the operation keys 12 to 16 on the operation panel 3 are provided with the protruding portions 12b to 16b respectively, this is in no way meant to limit the present invention. For the sole purpose of preventing the operation keys from being erroneously pressed, there is no need to provide the protruding portions for the lowest operation keys (the three lowest operation keys 12 and the operation keys 15 and 16). Protruding portions may be provided only for operation keys with a small operation surface or only for operation keys with small intervals between adjacent ones. Considering that, with the protruding portions provided, a finger is more likely to be held by the protruding portions, and thus that the intended one of the operation keys can be depressed more reliably, it is preferable to provide all operation keys with protruding portions.

For another example, although the previously-described fourth embodiment deals with an example where only the central operation keys 12d and 14 have their protruding portions formed in a shape different from the other protruding portions, this is in no way meant to limit the present invention. All the protruding portions may be formed in shapes different from one another.

The protruding portions may be labeled with characters, numbers, symbols, and the like. With this configuration, a user can more easily (seeks to) press the protruding portions; the user's finger is thus more likely to be held by the protruding portions, and thus the intended one of the operation keys can be depressed more reliably.

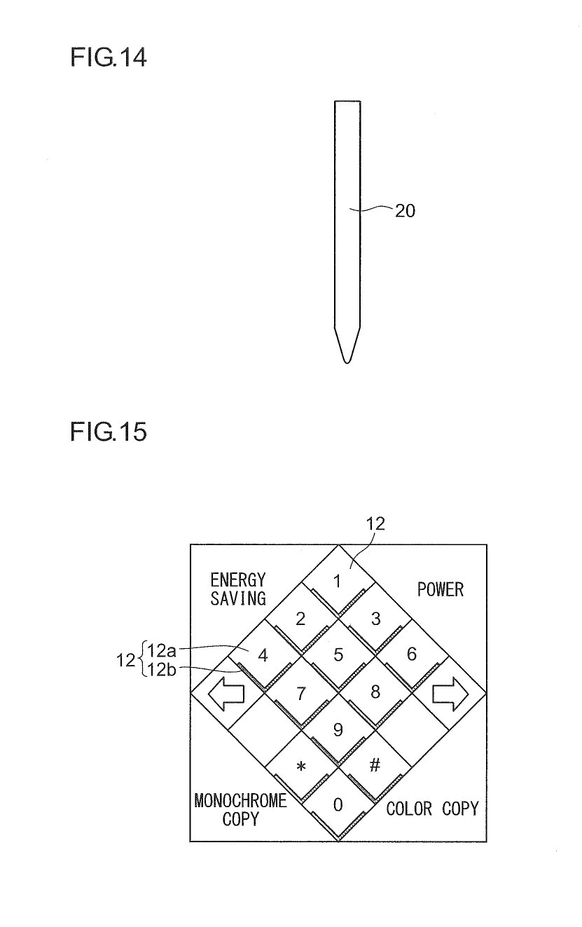

A pen-shaped stick 20 (see FIG. 14) for depressing the operation keys 12 to 16 on the operation panel 3 may be provided for an image forming apparatus or an image reading device. With this configuration, even when a large number of small operation keys for character input are arrayed on the operation panel 3 like a keyboard, it is possible to easily prevent the operation keys from being erroneously pressed.

For yet another example, although the previously-described ninth embodiment deals with an example where the plurality of operation keys 12 formed in a circular shape or an oval shape are arranged in a staggered array, this is in no way meant to limit the present invention. For example, as in the modified example of the present invention shown in FIG. 15, a plurality of operation keys 12 formed in a rhombic shape may be arranged in a staggered array. In this case, it is possible to achieve further space saving in the space necessary for the arrangement of the operation keys 12, and to improve the design.

The technical scope of the present invention encompasses any structure obtained by combining together different features from the above-described embodiments and modified examples as necessary.

1. An operation panel incorporated in an image forming apparatus or in an image reading device, the operation panel comprising:
a body having a panel surface which is inclined with respect to a horizontal direction; and
a plurality of operation keys protruding from the panel surface, wherein the operation keys have an operation surface which is depressed by a user, and have a protruding portion which is formed along a lower end part of the operation surface so as to protrude from the operation surface.

2. The operation panel of claim 1, wherein
the protruding portion is formed also in a side end part of the operation surface.

3. The operation panel of claim 1, wherein
a concavity is formed in a lower end part-side portion of the operation surface.

4. The operation panel of claim 1, wherein
the panel surface is inclined at 45 degrees or more with respect to the horizontal direction.

5. The operation panel of claim 1, wherein
in a predetermined operation key of the plurality of operation keys, the protruding portion has a different shape than in another operation key.

6. (canceled)

7. The operation panel of claim 1, wherein
the plurality of operation keys are formed such that a lower operation key has a larger protrusion amount of the protruding portion with respect to the operation surface than an upper operation key.

8. The operation panel of claim 1, wherein
the plurality of operation keys are formed such that a lower operation key has a larger protrusion amount of the operation surface with respect to the panel surface than an upper operation key.

9. The operation panel of claim 1, wherein
the protruding portion protrudes from the operation surface in the horizontal direction.

10. The operation panel of claim 1, wherein
an upper end part of the operation surface is chamfered.

11. The operation panel of claim 1, wherein
the plurality of operation keys are arranged in a staggered array.

12. The operation panel of claim 11, wherein
the plurality of operation keys are formed in a rhombic shape.

13. The operation panel of claim 1, wherein
the protruding portion is labeled with a character, a number, or a symbol.

14. The operation panel of claim 1, wherein
a light emitting element is provided in the body, and
the protruding portion is formed as a light guiding portion through which light from the light emitting element is transmitted.

15. An image forming apparatus comprising the operation panel of claim 1.

16. The image forming apparatus of claim 15, further comprising
a pen-shaped stick for depressing the operation key.

17. An image reading device comprising the operation panel of claim 1.
